(19) United States
(12) Patent Application Publication
(10) Pub. No.: US 2026/0164288 A1
(43) Pub. Date: Jun. 11, 2026

(54) QOS ADJUSTMENTS BASED ON WTRU SPEED, LOCATION, AND TRAJECTORY

(71) Applicant: InterDigital Patent Holdings, Inc., Wilmington, DE (US)

(72) Inventors: Achref Methenni, Montreal (CA); Subhramoy Mohanti, Santa Clara, CA (US); Michael Starsinic, Newtown, PA (US); Xavier De Foy, Kirkland, CA (US); Michel Roy, Candiac (CA); Rocco Di Girolamo, Laval (CA); Samir Ferdi, Kirkland (CA); Kevin Di Lallo, Laval (CA); Magurawalage Chathura Madhusanka Sarathchandra, London (GB)

(73) Assignee: InterDigital Patent Holdings, Inc., Wilmington, DE (US)

(21) Appl. No.: 18/940,670

(22) Filed: Nov. 7, 2024

(51) Int. Cl. H04W 28/02; H04W 64/00

(52) U.S. Cl. CPC H04W 28/0226; H04W 28/0268; H04W 64/006

(57) ABSTRACT

Systems and methods are disclosed for adjusting quality of service (QoS) based on the speed, location, and trajectory of a wireless transmit receive unit (WTRU). A first network node, such as a radio access network (RAN), may receive QoS profiles from a second node, like a session management function (SMF), and a profile may be associated with WTRU movement parameters and indices. Upon detecting changes in the WTRU's speed, location, or trajectory, the first network node may select an appropriate QoS profile and sends an index for the profile to the WTRU and a third node, such as a user plane function (UPF), to synchronize QoS handling.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are disclosed for quality of service (QoS) adjustments based on wireless transmit receive unit (WTRU) speed, location, and trajectory. A first network node (e.g., a radio access network (RAN) may receive, from a second network node (e.g., a session management function (SMF)), a first message that may include QoS profiles. The QoS profiles may be associated with respective WTRU movement information associated with a WTRU, and the QoS profiles may be associated with respective indices. The first network node may determine, based on one or more of a measurement or information; or a change in one or more of a speed, location, or trajectory of the WTRU. The first network node may select a QoS profile from the QoS profiles based on the determined change in the one or more of speed, location, or trajectory of the WTRU. The first network node may send, to the WTRU, a third message including an index from the respective indices to indicate the selected QoS profile. The index may be associated with the selected QoS profile. The first network node may send to a third network node (e.g., a user plane function (UPF)), a fourth message that may include the index. The fourth message may be associated with synchronizing QoS handling for the WTRU.

The one or more of the measurement or information may be received from the WTRU, a location management function (LMF), or a network data analytics function (NWDAF). The QoS profiles may include respective packet delay budget values associated with the respective WTRU movement information. Determining the change in the one or more of the speed, location, or trajectory of the WTRU may include estimating the speed of the WTRU based on the one or more of the measurement or information. The first network node may send to the second network node a fifth message indicating the selected QoS profile. The QoS profiles may include respective packet error rate (PER) values associated with the respective WTRU movement information.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows a RAN that is configured with quality of service (QoS) parameter sets associated with WTRU movement information and to detect WTRU movement and select QoS parameters accordingly.

FIG. 3 shows an example flowchart 300 of an example that may be executed, as described herein.

### DETAILED DESCRIPTION

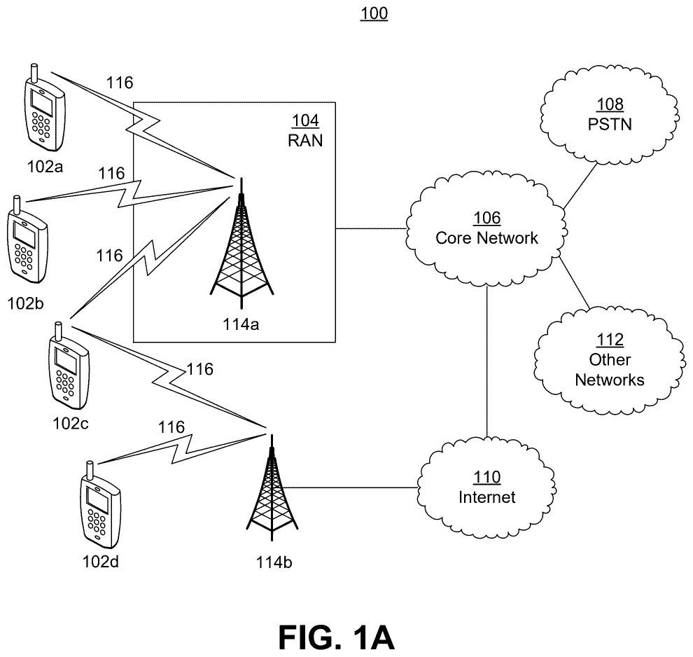

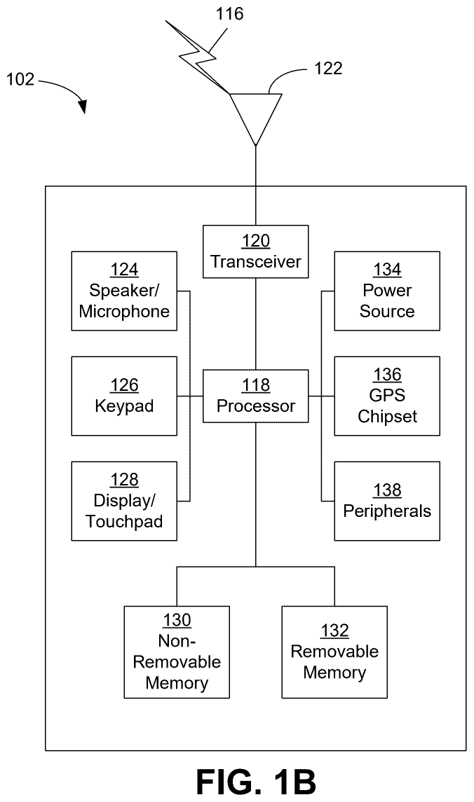

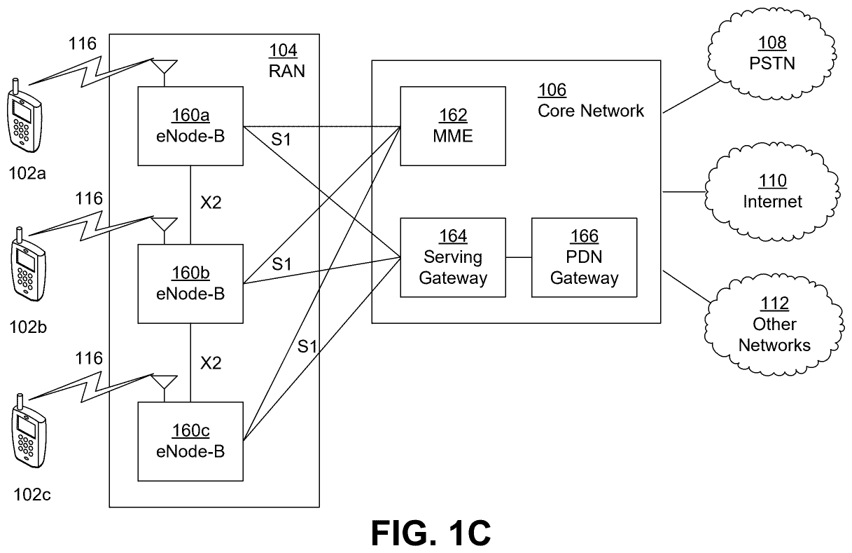

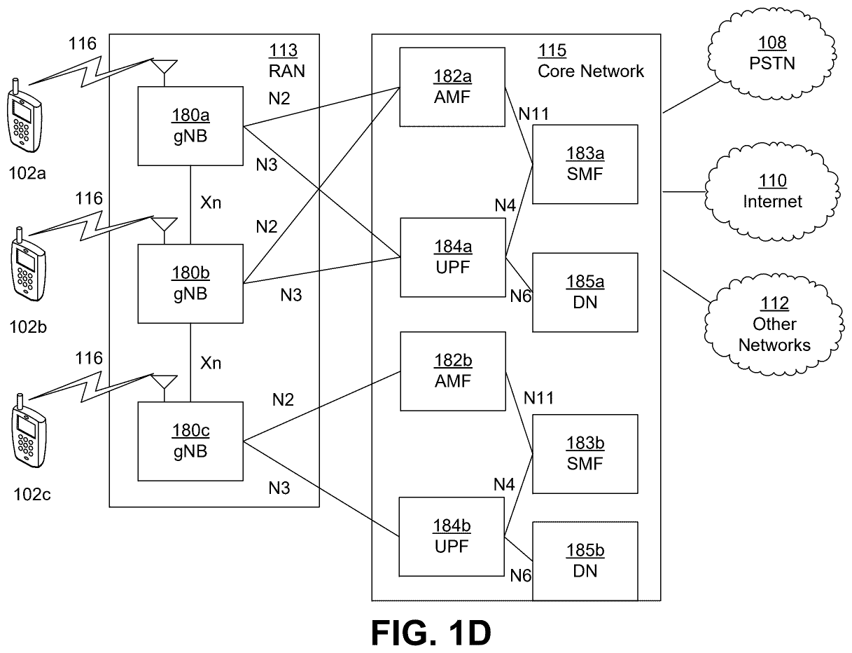

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Abbreviated terms and their respective meanings as described herein are included in Table 1.

TABLE 1

| | |
|---|---|
| 5GS | 5G System |
| 5QI | 5G QoS Identifier |
| AF | Application Function |
| ARP | Allocation and Retention Priority |
| API | Application Programming Interface |
| AS | Application Server |
| DL | Downlink |
| GBR | Guaranteed Bit Rate |
| GFBR | Guaranteed Flow Bit Rate |
| GTP | GPRS Tunnelling Protocol |
| GTP-U | GTP User Plane |
| IE | Information Element |
| LMF | Location Management Function |
| MFBR | Maximum Flow Bit Rate |
| MT | Mobile Terminal |
| NEF | Network Exposure Function |
| NWDAF | Network Data analytics Function |
| PCC | Policy and Charging Control |
| PCF | Policy Control Function |
| PDB | Packet Delay Budget |
| PDU | Packet Data Unit |
| PER | Packet Error Rate |
| QFI | QoS Flow Identifier |
| QoS | Quality of Service |
| RAN | Radio Access Network |
| RQA | Reflective QoS Attribute |
| RRC | Radio Resource Control |
| SM | Session Management |
| SMF | Session Management Function |
| TE | Terminal Equipment |
| UE | User Equipment |
| UL | Uplink |
| UPF | User Plane Function |
| XRM | Extended Reality and Media Services |

A RAN node may be described at least as a base station, gNodeB, or eNodeB. The RAN node may receive a message from an SMF, which may include QoS Profiles, WTRU movement information that is associated with a QoS Profile, and an index that is associated with a (e.g., each) QoS Profile.

The RAN node may be configured to obtain or determine WTRU speed, location, or trajectory information, for example, based on measurements, information that is received from an LMF, and/or information that is received from an NWDAF.

The RAN may select a QoS Profile based on the determined WTRU speed, location, or trajectory information and based on the WTRU movement information that is associated with a QoS Profile.

The RAN may send the index that is associated with the selected QoS Profile to a WTRU in an RRC Message and send the index that is associated with the selected QoS Profile to a UPF in a GTP-U Message.

A RAN node may perform the following actions. The RAN node may receive a message from an SMF. The message may include QoS profiles, WTRU movement information that is (e.g., respectively) associated with a QoS Profile, and an index that is associated with a QoS Profile.

The RAN node may determine WTRU speed, location, or trajectory information. The WTRU speed, location, or trajectory information may be based on measurements, information that is received from an LMF, and/or information that is received from an NWDAF.

The RAN node may select a QoS Profile based on the determined WTRU speed, location, or trajectory information, and based on the WTRU movement information associated with a QoS Profile. The RAN node may send the index associated with the selected QoS Profile to a WTRU in an RRC Message. The RAN node may send the index associated with the selected QoS Profile to a UPF in a GTP-U Message.

Features described herein may include WTRU actions. The WTRU may perform (e.g., the MT part of the WTRU may perform) the following actions. The WTRU may receive a message from an SMF. The message may include QoS rules, WTRU movement information associated with a QoS rule, and an index is associated with a QoS rule. The WTRU may determine WTRU speed, location, or trajectory information. The WTRU speed, location, or trajectory information is based on information that is received from an application that runs in the TE part of the WTRU. The WTRU may select a QoS rule based on the determined WTRU speed, location, or trajectory information. The WTRU may select a QoS rule based on the WTRU movement information associated with a QoS rule. The WTRU may send the index associated with the selected QoS rule to a RAN node in an RRC message.

The RAN node may be provided with QoS profiles from the SMF. A QoS profile may include information related to the QoS aspects (e.g., QoS parameters, characteristics) of a QoS flow that is set up or established within a PDU Session. The QoS profile may include a 5QI value and an ARP value. The QoS profile may include GFBR and MFBR values for DL and UL directions when the QoS flow is a GBR QoS flow. The QoS profile may include (e.g., 5G) QoS characteristics, such as packet delay budget (e.g., PDB) value, packet error rate (e.g., PER) value, a priority level value, etc. The RAN may use the QoS profile to apply QoS treatment of packets belonging to the QoS flow that corresponds to the QoS profile.

In examples, a user/WTRU may be inside a vehicle. The WTRU may be running an application with an application server, and for which the data is exchanged via a mobile system (e.g., 5GS). For example, the WTRU may capture images from the road where the vehicle is located, and the WTRU may send the recorded images to an application server in the uplink direction.

The user plane data may be carried in the user plane tunnel between the WTRU and an anchor UPF, which may forward the uplink data to the AS.

Once the AS receives the data, the AS may process the received images about the vehicle's surroundings, including the road traffic. The AS may process the images to help detect an obstacle that the vehicle may encounter on the road. The AS may determine whether the road traffic is congested and how much road traffic there is. The AS may detect an unexpected event taking place in the trajectory that the vehicle is taking and assess how soon the event may take place.

The application data flow may have (e.g., different) QoS parameters (e.g., requirements) depending on the aspects related to the WTRU/vehicle speed, location, and trajectory. In examples, if a vehicle has a 1 km/h speed, in order to be able to detect an event or obstacle that is located 100 meters on the WTRU trajectory, the WTRU/vehicle may determine or obtain information about the event (e.g., from the AS) and react in a time duration of 100/1000*60=6 minutes. If the vehicle has a speed of 100 km/h, the WTRU/vehicle may determine or obtain information about the event (e.g., from the AS) and react within a time duration of 100/100000*60=3.6 seconds. If the vehicle is not moving, e.g., in a parking spot or standing on the side of a highway, there may be less urgency to inform the WTRU in the vehicle about road traffic information.

When the vehicle is detected to be in a highway or about to be in a highway, the application data may be provided to the AS and received by the vehicle in a delay (e.g., short delay), which may include an indication related to the road traffic information.

Considering the packet delay budget of the QoS flow as an example of a QoS parameter, the PDB parameter (e.g., requirement) may vary and be adjusted depending on WTRU speed, location, and trajectory.

Application layer approaches to rate adaptation may be associated with error detection and adaptation. Such an approach may be associated with a reaction time. Over provisioning of QoS Flows (e.g., assuming the lowest PDB) may be associated with a use of network resources. In examples, QoS parameters (e.g., requirements) may be configured and adjusted based on a WTRU movement (including WTRU speed, location, and trajectory). In examples, the RAN may be configured to detect a change in WTRU speed, location, or trajectory values, and select the QoS profile based on the obtained values.

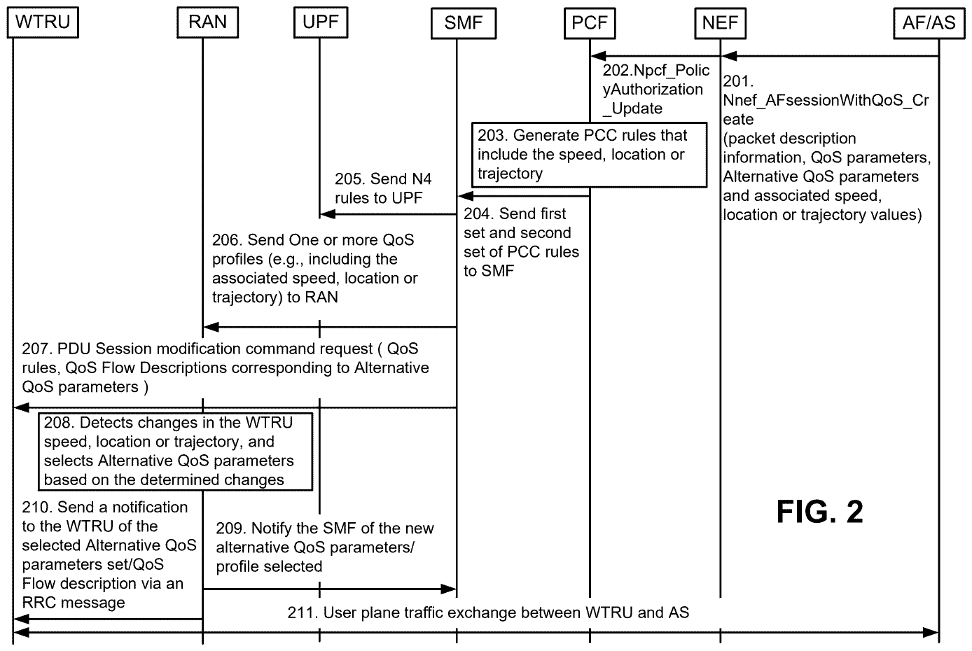

FIG. 2 shows a RAN that is configured with QoS parameter sets associated with WTRU movement information and to detect WTRU movement and select QoS parameters accordingly. FIG. 2 shows an example where the SMF configures the RAN node with a set of QoS parameters that are associated with information related to WTRU movement. The RAN may be configured to obtain information about current or expected WTRU movement (e.g., including WTRU speed, location, and trajectory).

FIG. 2 shows how the SMF may configure the WTRU with multiple sets of QoS parameters that are associated with WTRU movement information. The WTRU may be configured to select a QoS parameters set according to WTRU movement information that is provided by the RAN node after RAN determination.

At 201, the application function (e.g., AF) may send a message to the 5GS to request (e.g., require) to reserve resources for an application session. The AF may send this message to the NEF using an NEF API, such as the Nnef_AFsessionWithQoS_create service operation.

The AF may provide packet flow description information to allow the system (e.g., 5GS) to identify the traffic flow of interest that may be exchanged between the WTRU and AS. The AF may include a QoS reference or QoS parameters for the traffic flow of interest.

The AF may include an indication that WTRU movement information is to be considered when setting up QoS flows and related QoS parameters for the traffic flow of interest.

The WTRU movement information element (Mov IE) may include values that reflect the WTRU movement state associated with the provided QoS parameters. For example, the AF may associate the WTRU movement state=stationary to indicate that the first set of QoS parameters may be fulfilled when the WTRU is associated with a WTRU movement state that is stationary. When the WTRU is not moving or is moving very slowly, the first set of QoS parameters may be provisioned.

Values for the WTRU movement state may be mobile. The WTRU Mov IE may include attributes related to the WTRU movement state. For example, the WTRU may be in a moving state, and the WTRU may be characterized by a slow, medium, or fast attribute.

The WTRU Mov IE may include information related to WTRU speed. This may include a WTRU speed value or a WTRU speed value range. For example, the WTRU Mov IE WTRU speed may have values 1 km/h, 20 km/h, or 100 km/h. In the previous example, the first set of QoS parameters may be associated with a WTRU speed of 1 km/h or less.

The WTRU Mov IE may include information about the WTRU location that is associated with the QoS parameters that are to be fulfilled for the QoS flow carrying the application data flow of interest exchanged between the WTRU and UPF. For example, the WTRU location may indicate city,” suburban, or highway values for the WTRU location.

The WTRU location may include numerical values that represent a specific location area or geographical area. The WTRU Mov IE may include information about the WTRU trajectory. For example, a trajectory from suburban area 1 to suburban area 2 may indicate that the road may not be crowded, and depending on WTRU speed, the trajectory from suburban area 1 to suburban area 2 may indicate that the application data flow is not as urgent as when the WTRU has a trajectory from city area 1 to city area 2 and WTRU speed is medium.

The WTRU Mov IE may include information related to the WTRU or device altitude, for example, if the device may be a UAV device. The AF may include auxiliary or multiple QoS parameters sets that are associated, a (e.g., each) with a certain WTRU movement information.

In an example (e.g., of the packet delay budget (e.g., PDB) as a QoS parameter that may be provided by the AF), the AF may indicate that the requested (e.g., required) PDB is 20 ms for the application data flow of interest when the WTRU is stationary or slowly moving or in a parking spot. The requested PDB for WTRU movement information that indicates a High-speed WTRU or WTRU trajectory including a nearby highway may have a value of 10 ms (e.g., a stricter PDB parameter (e.g., requirement) when the WTRU may be in the highway or may be moving with high speed).

In examples of the packet error rate (e.g., PER) as a QoS parameter that may be provided by the AF, the AF may indicate a PER parameter (e.g., requirement) of 1/100 error rate when the associated WTRU speed is slow or WTRU is in a low-risk area (e.g., a parking area), whereas the AF may indicate the PER parameter (e.g., requirement) of 1/10000 error rate when the associated WTRU movement information indicates a high WTRU speed or a WTRU heading to a highway area with a medium to high speed.

The AF may invoke an NEF API to provide the NEF with a flow description and multiple QoS References for the flow description or multiple sets of QoS Parameters for the flow description. The AF may provide a WTRU Mov IE to associate with a QoS Reference or a set of QoS Parameters. The AF may configure the network with information that may be used to configure the QoS of a flow based on the observed or anticipated movements of the WTRU.

At 202, the NEF may authorize the AF request and forward the service parameters to the PCF. For example, the NEF may send the flow description, QoS References or sets of QoS Parameters, and corresponding sets of WTRU movement information to the PCF.

At 203, the PCF may determine a policy and charging control (PCC) rule for the service data flow.

Based on the information provided by the NEF/AF, the PCF may configure a PCC rule that includes multiple sets of QoS parameters for the flow. The PCC rule may indicate the conditions under which a set of QoS parameters may apply. The conditions may be based on the WTRU movement information that was provided by the NEF/AF. The PCC rule may indicate a set of QoS parameters that may be used if the WTRU's movement information (e.g., speed or location) cannot be determined within some degree of certainty.

For example, the PCC rules may indicate that one set of the QoS parameters may be used if the WTRU may be traveling above a first certain speed in a first certain location and that a second set of the QoS parameters may be used if the WTRU may be traveling above a second certain speed in a second certain location.

For example, the PCC rules may indicate that a (e.g., one) set of the QoS Parameters may be used if the WTRU's trajectory is close to a first certain location and that a second set of the QoS Parameters may be used if the WTRU's trajectory is close to a second certain location.

For example, the initial PDB value may be set to PDB1=20 ms, with WTRU movement set to stationary, PDB value PDB2=15 ms for an associated WTRU with a speed value may be under 30 km/h, and PDB value PDB3=7 ms for an associated WTRU with a speed value of over 30 km/h or when a trajectory coverage includes a highway type of area.

The PCF may determine information related to a method for obtaining the WTRU movement information by the entities of interest (e.g., the RAN node). The information may be called a WTRU movement monitoring information element.

The WTRU movement monitoring IE may indicate which variables or attributes are to be obtained in order to assess which QoS parameter sets are to be used for the application data flow. For example, the PCF may determine that the WTRU trajectory information or WTRU location is to be retrieved or obtained in order to determine the PDB value (or PER value or other QoS parameter values) for the service data flow of interest.

The PCF may also determine that a WTRU speed is to be obtained/derived in order to determine or set the corresponding QoS parameters set. The PCF may determine which entity may obtain or derive the WTRU movement information and the WTRU movement monitoring parameters.

For example, the PCF may determine that the RAN node is the entity that is to determine/retrieve the WTRU movement information. The PCF may determine that the RAN obtains the WTRU movement information or retrieves related information from an LMF function.

The PCF may determine whether periodic WTRU movement information is needed. The PCF may determine that information about the WTRU movement may be obtained when certain conditions are fulfilled. For example, the RAN may subscribe to WTRU movement status notification to the LMF and request to be notified when the WTRU changes movement status from stationary to moving. For example, the RAN may request to be notified by the LMF when the WTRU speed changes from a certain value, reaches a value lower than 50 km/h, to a new value that is higher than 50 km/h, and request to be provided with the corresponding WTRU speed value.

At 204, the PCF may send the PCC rules to the SMF. The SMF may use the PCC rule received from the PCF to determine N4 rules for the UPF, QoS profiles for the RAN node, and QoS rules for the WTRU. Using the PCC rule, the SMF determines a list of QoS profiles to be used by the RAN node. A QoS profile may include QoS parameter values and QoS characteristics for the QoS flow of interest.

The QoS profile may include WTRU movement information values associated with the QoS parameters included in the QoS profile. This information may include speed, location, and trajectory information.

Since the AF provides one or more sets of QoS parameters, and a set may be associated with WTRU movement information values, the SMF may generate a QoS profile for a set of QoS parameters. The SMF may include the values of the associated WTRU movement information in the QoS profile.

For example, a QoS profile may have an indication that the PDB value is 20 ms for the QoS flow of interest, with WTRU being stationary, or WTRU speed being less than 1 km/h, or if the WTRU is in a low-risk area. A QoS profile may have an indication that the PDB value is 10 ms for the QoS flow of interest, with a WTRU moving and a WTRU speed being between 2 km/h and 30 km/h. A QoS profile may have a PDB value of 7 ms for the QoS flow, with a WTRU moving with a high speed, e.g., a speed value above 30 km/h, or the WTRU is in a highway area.

The SMF may send information to the RAN node to instruct the RAN to determine or obtain current WTRU movement information, such as speed, trajectory, and location. For example, the SMF may instruct the RAN to expect current WTRU movement information from the PCF via the SMF.

The RAN node may be configured to expect the WTRU movement information reporting from the PCF via the SMF periodically, using a certain period value provided to the RAN.

In order for the RAN node to determine which initial QoS profile is to be set or selected for the QoS flow of interest, the RAN may obtain WTRU movement information, including WTRU speed, location, and trajectory.

The SMF may obtain WTRU movement information, e.g., by interaction with the PCF or the LMF. The SMF may send the initial WTRU movement information to the RAN node to enable the RAN node to select an initial QoS profile for the QoS flow of interest.

For example, if the SMF determines that initial/current WTRU speed is less than 1 km/h or that the WTRU may be stationary, the SMF may send this information to the RAN node, and the RAN may choose the QoS profile that corresponds to a PDB parameter (e.g., requirement) of 20 ms, as an initial QoS profile.

If the SMF determines that the initial/current WTRU speed is 20 km/h, the SMF may send this information to the RAN node, and the RAN may select the QoS profile that corresponds to a PDB parameter (e.g., requirement) of 15 ms, as an initial QoS profile.

The SMF may derive QoS rules for the WTRU. The QoS rules may describe the mapping of certain service data flows to the corresponding QoS Flow Identifier (e.g., QFI). The SMF may derive a QoS flow description for the QoS flow of interest. The QoS flow description may include a QFI value and information related to the treatment of the flow. For example, if the QoS flow is of a GBR type, the QoS flow description may include values of GFBR and MFBR for the DL and UL directions for the QoS flow.

The QoS flow description may include information related to WTRU speed, location, and trajectory (e.g., WTRU movement information) and may include a QoS treatment depending on the values of the WTRU speed, location, and trajectory.

The SMF may derive a QoS flow description for the QoS flow of interest, for (e.g., different) values of WTRU movement information (e.g., WTRU speed, location, and trajectory) that are associated with a set of QoS parameters (e.g., provided by the AF at 201).

For example, the QoS flow description may include a GFBR UL value for the QoS flow of interest when the associated WTRU movement indicates a stationary WTRU or a slowly moving WTRU with a speed value less than 1 km/h. The QoS flow description may include a different (e.g., higher) GFBR value for the QoS flow of interest when the associated WTRU movement information indicates a moving WTRU, with a WTRU speed between 2 km/h and 30 km/h, etc.

The SMF may use the PCC rules to derive multiple sets of N4 rules, QoS Profiles, and QoS rules. A set of N4 rules, QoS Profiles, and QoS rules may be associated with an index and WTRU movement information. The WTRU movement information may indicate under what conditions the N4 rules, QoS Profiles, and QoS rules are to apply.

At 205, the SMF may send the sets of N4 rules to the UPF. The WTRU movement information may (or may not) be sent to the UPF and may (or may not) be included in the N4 rules.

At 206, the SMF may send the sets of QoS Profiles to the RAN node. The WTRU movement information may be sent to the RAN node and may be included in the QoS Profiles.

At 207, the SMF may send the multiple sets of QoS rules to the WTRU. The WTRU movement information may (or may not) be sent to the WTRU and may (or may not) be included in the QoS rules.

The RAN node may determine that the QoS Profile that includes an indication that it is the default QoS Profile may be applied to the traffic, and the RAN node may apply the corresponding QoS Profile. The RAN node may send an RRC Message to the WTRU, and the RRC Message may indicate the index that corresponds to the QoS Profile that the RAN node selected. The WTRU may know to apply the QoS rules that correspond to the index. The RAN node may send a GTP-U Message to the UPF, and the GTP-U Message may indicate the index that corresponds to the QoS Profile that the RAN node selected. The UPF may know to apply the N4 rules that correspond to the index. The WTRU and Application server may send and receive data with the traffic flow, and the traffic flow may receive QoS treatment based on the QoS Profile that was selected by the RAN node.

At 208, the RAN node (also referred to herein as RAN) may obtain or determine information related to WTRU movement. The RAN may receive information about the current WTRU movement status (e.g., whether the WTRU is stationary or moving, values for the current WTRU speed, location, and updates in the WTRU trajectory). The RAN node may receive the information from a network node, such as the PCF via the SMF, after the network node (e.g., the PCF) has interacted with the LMF function to determine or obtain the WTRU location, trajectory, and speed information. The WTRU movement information may describe whether the WTRU is in an area such as a highway or in an area that is similar to a parking place.

The WTRU movement information may indicate whether a change occurred in the WTRU speed, location, or trajectory. For example, the RAN may determine that the WTRU location switched from the parking place location to a highway, based on information received from the SMF about WTRU movement. The RAN may determine the last or previous WTRU movement information values that the RAN may have.

The RAN may use the obtained information in the WTRU speed, location, and trajectory to select the QoS profile that corresponds to the determined WTRU speed, location, and trajectory information. The RAN node may detect changes in the WTRU trajectory, speed, or location. For example, the RAN node may use measurements of radio signals that are transmitted from the WTRU to estimate the WTRU speed. For example, the RAN node may receive WTRU location information from an LMF. For example, the RAN node may receive predictions of WTRU speed, trajectory, or location from an NWDAF. An indication that the WTRU is stationary may be a type of trajectory information.

Based on the updated speed, location, or trajectory information, the RAN node may determine that a QoS Profile (e.g., a different QoS profile) may be applied to the traffic, and the RAN node may apply the corresponding QoS Profile. The RAN node may send an RRC Message to the WTRU, and the RRC Message may indicate the index that corresponds to the new QoS Profile that the RAN node selected. The WTRU may know to apply the QoS rules that correspond to the new index. The RAN node may send a GTP-U Message to the UPF, and the GTP-U Message may indicate the new index that corresponds to the new QoS Profile that the RAN node selected. The UPF may know to apply the N4 rules that correspond to the new index.

At 209, the RAN node may send a notification message to the SMF to indicate which QoS profile the RAN node has selected for the QoS flow of interest, based on the updated values of WTRU speed, location, and trajectory.

At 210, the RAN node may send the RRC message to the WTRU, and the RRC message may indicate the index that corresponds to the updated QoS profile that the RAN node selected. The RAN may send the notification message to the WTRU via an RRC message.

At 211, the WTRU may exchange traffic with the application server, using the QoS flow with the updated QoS parameters.

The PCF may obtain WTRU speed, location, and trajectory information from the LMF. In examples, the PCF may determine to request or subscribe to WTRU movement information. The PCF may determine to subscribe to the LMF in order to obtain WTRU speed, location, and trajectory, according to the monitoring and reporting criteria. The PCF may determine to subscribe to WTRU movement information to the LMF based on the indication from the AF that WTRU movement information may be taken into consideration for QoS parameters and QoS flow setup.

In examples, the PCF may obtain updated WTRU movement information from the LMF. The PCF may use the obtained updated WTRU movement information to determine which set of QoS parameters is to be selected for the QoS flow that carries the application flow of interest. The PCF may update the PCC rule and select the QoS parameters set. The PCF may send the updated PCC rule or the PCC rule and the index of the QoS parameters set to be used, to the SMF. The SMF may update or select N4 rules to be used by the UPF and a QoS profile to be used by the RAN node. The SMF may send the index of the QoS parameters set to the UPF and RAN. The RAN may use the index to select the QoS profile to use for the application flow. The UPF may use the received index to select the N4 rule that is to be applied for the application flow of interest.

The PCF may obtain updated WTRU movement information from the LMF. The PCF may send the updated information to the RAN. For example, the PCF may send the information to the SMF, and the SMF may forward the information to the RAN.

The RAN may use the updated WTRU movement information to determine a change in WTRU speed, location, or trajectory. The RAN may select the QoS profile that corresponds to the obtained WTRU movement information values.

The SMF may request/subscribe to WTRU speed, location, and trajectory information from the LMF. The SMF may be triggered to request or subscribe to WTRU movement information from the LMF. The SMF may obtain WTRU speed, location, and trajectory from the LMF according to the criteria provided by the SMF.

The SMF may send the obtained WTRU movement information to the RAN. The SMF may use the information received from the LMF to generate an indication that WTRU movement information may have changed. For example, the SMF may use the obtained WTRU speed, compare the obtained WTRU speed with the previous WTRU speed value, and determine that WTRU speed changed considerably. The SMF may send a message to the RAN node to indicate a WTRU speed change and provide the updated WTRU speed value or related information. The SMF may send the information to the RAN using an N2 SM message.

The SMF may send the obtained WTRU movement information, such as updated WTRU speed, to the RAN node. The RAN node may compare the updated WTRU speed value with the current WTRU speed value (e.g., the RAN may have this old WTRU speed value as the RAN uses the old WTRU speed value to select the appropriate QoS profile for the QoS flow). The RAN may determine based on the two values that a WTRU speed change took place. The RAN may use the determination together with the updated WTRU speed information (or obtained WTRU movement information) to select the corresponding QoS profile.

In examples, the system (e.g., 5GS) may provide predictions about a likelihood of a WTRU speed change given the current WTRU movement status (e.g., whether the WTRU is moving or not currently) and current WTRU speed, and location.

For example, the NWDAF may provide analytics that are related to WTRU movement, including WTRU speed, location, and trajectory. For example, WTRU mobility analytics may be used to provide such analytics.

The SMF may request or subscribe to WTRU mobility or movement analytics to the NWDAF. Once the SMF receives an analytics output update, the SMF may determine that the WTRU speed may likely increase soon. In examples, the SMF may determine, based on WTRU mobility rate analytics, that the WTRU may likely go through a highway and is to maintain a WTRU speed of at least 40 km/h for the next 15 minutes. The SMF may send such WTRU speed, location, and trajectory-related information to the RAN. The RAN node may use the updated WTRU movement information to select the (e.g., appropriate) QoS profile for the QoS flow of interest.

The WTRU may be involved in the determination of the WTRU movement information, such as WTRU speed, location, and trajectory. The WTRU may exchange information with the system (e.g., 5GS), for example, the UPF via the user plane, to allow the UPF or the SMF to derive updated WTRU movement information.

The WTRU may send information to the RAN node, and the RAN may use such information to determine measurements related to WTRU location, speed, and trajectory.

The RAN may obtain information related to WTRU movement from the system (e.g., 5GS) network functions that provide predictions of the WTRU movement information. For example, the system (e.g., 5GS) may provide predictions of WTRU trajectory or WTRU trajectory update in a certain time window in the future (e.g., in 3 mins).

Data boosting may be used to update QoS treatment based on WTRU speed, location, and trajectory information.

The system (e.g., 5GS) may leverage a data boosting feature to use the QoS parameters (e.g., appropriate QoS parameters) based on the AF parameters (e.g., requirements) and the WTRU speed, location, and trajectory information.

The AF may provide the NEF with two sets of QoS parameters for the application flow of interest. The first set of QoS parameters may represent initial QoS parameters that are to be fulfilled when carrying the application data. This first set of QoS parameters may be associated with information related to WTRU speed, location, and trajectory that is associated with the use of the QoS parameters. The first set of QoS parameters may be assumed to be associated with a normal or non-urgent QoS treatment of the service data flow of interest.

For example, the PDB parameter (e.g., requirement) in an example of a QoS parameter (e.g., QoS parameter set) may be PDB1=20 ms, and the associated WTRU movement information may include the following information: WTRU state is stationary, WTRU speed is below 1 km/h, WTRU is far from a highway or congested road traffic area.

The AF may provide a second set of QoS parameters that are associated with an urgent or expedited QoS treatment of the service data flow of interest. The second set of QoS parameters may be associated with information related to WTRU speed, location, and trajectory.

For example, the PDB parameter (e.g., requirement) in an example QoS parameters set is PDB2=7 ms, and the associated WTRU movement information may include the following information: WTRU speed is above 40 km/h, WTRU is heading towards a highway, WTRU is to maintain the speed above 40 km/h for 15 minutes.

The system (e.g., 5GS), for example, the PCF, may generate two PCC rules for a set of QoS parameters. The two QoS parameter sets may be associated with a QoS flow and an expedited or urgent treatment QoS flow.

The SMF or PCF may request or subscribe to WTRU movement information, e.g., to the LMF. The SMF or PCF may request the LMF to provide updated or up-to-date measurement, estimate, or information of WTRU speed, location, and trajectory. If the application data is initially carried using the QoS flow, and if the SMF determines that WTRU speed becomes (e.g., considerably) high or WTRU is entering a highway, based on the WTRU movement information obtained from the LMF, the SMF may indicate to the UPF that expedited treatment is to be used, and to use the expedited QoS flow to carry the application data.

The UPF may receive a notification about WTRU speed, location, and trajectory change, for example, from the SMF, and the UPF may determine that an expedited QoS treatment is needed and decides to send the application data over the expedited QoS flow.

The UPF may mark the application PDUs with a reflective QoS attribute (e.g., RQA) set to 1, for example, that reflective QoS is enabled or active for the application data.

The WTRU may use the RQA indication and the value of QFI (e.g., the QFI refers to the QFI of the expedited QoS flow) to update the QoS rules for the application flow and send the uplink traffic over the expedited QoS flow.

QoS changes may be WTRU triggered. In FIG. 1, the RAN node may detect changes in WTRU speed, location, or trajectory. Based on the detected change, the RAN node may switch what QoS profile applies and indicate an index to the WTRU and UPF, so that the WTRU and UPF may determine what QoS rules and N4 rules may be applied.

An example approach may be that the WTRU movement information may be sent to the WTRU with the QoS rules at 207, and the WTRU movement information may (or may not) be sent to the RAN node at 206. The WTRU may detect changes in WTRU trajectory, location, or speed. The WTRU may use the WTRU trajectory, location, or speed information to determine which set of QoS rules may be applied. The WTRU may send an RRC message to the RAN node to provide the RAN node with the index of the selected QoS rules. The RAN node may use the index to determine which QoS profile may be applied. The RAN node may send the index to the UPF so that the UPF knows which set of N4 rules to apply.

The WTRU may detect changes in WTRU trajectory, location, or speed based on information that the MT part of the WTRU receives from an application that runs in the TE part of the WTRU.

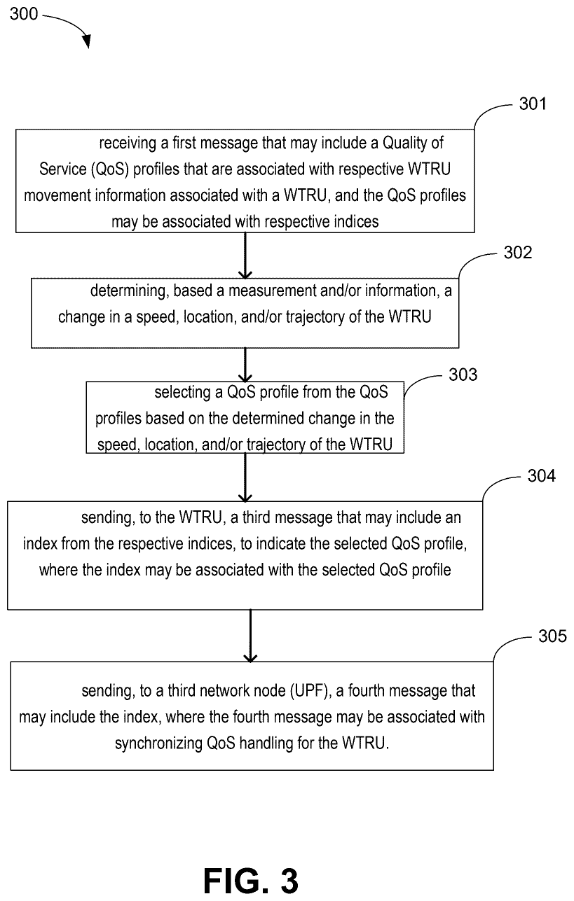

FIG. 3 shows an example flowchart 300 of an example that may be executed, as described herein. Systems, methods, and instrumentalities are disclosed for quality of service (QoS) adjustments based on wireless transmit receive unit (WTRU) speed, location, and trajectory.

At 301, a first network node (e.g., a radio access network (RAN) may receive, from a second network node (e.g., a session management function (SMF)), a first message that may include QoS profiles. The QoS profiles may be associated with respective WTRU movement information associated with a WTRU, and the QoS profiles may be associated with respective indices.

At 302, the first network node may determine, based on one or more of a measurement or information; or a change in one or more of a speed, location, or trajectory of the WTRU.

At 303, the first network node may select a QoS profile from the QoS profiles based on the determined change in the one or more of speed, location, or trajectory of the WTRU.

At 304, the first network node may send, to the WTRU, a third message including an index from the respective indices to indicate the selected QoS profile. The index may be associated with the selected QoS profile.

At 305, the first network node may send to a third network node (e.g., a user plane function (UPF)), a fourth message that may include the index. The fourth message may be associated with synchronizing QoS handling for the WTRU.

The one or more of the measurement or information may be received from the WTRU, a location management function (LMF), or a network data analytics function (NWDAF). The QoS profiles may include respective packet delay budget values associated with the respective WTRU movement information. Determining the change in the one or more of the speed, location, or trajectory of the WTRU may include estimating the speed of the WTRU based on the one or more of the measurement or information. The first network node may send to the second network node a fifth message indicating the selected QoS profile. The QoS profiles may include respective packet error rate (PER) values associated with the respective WTRU movement information.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A first network node (RAN) comprising a processor configured to:
receive, from a second network node (Session Management Function (SMF), a first message comprising a plurality of Quality of Service (QoS) profiles, wherein the plurality of QoS profiles are associated with a plurality of respective WTRU movement information associated with a WTRU, and wherein the plurality of QoS profiles are associated with a plurality of respective indices;
determine, based on one or more of a measurement or information, a change in one or more of a speed, location, or trajectory of the WTRU;
select a QoS profile from the plurality of QoS profiles based on the determined change in the one or more of speed, location, or trajectory of the WTRU;
send, to the WTRU, a third message comprising an index from the plurality of respective indices, to indicate the selected QoS profile, wherein the index is associated with the selected QoS profile; and
send, to a third network node (UPF), a fourth message comprising the index, wherein the fourth message is associated with synchronizing QoS handling for the WTRU.

2. The first network node of claim 1, wherein the first network node comprises a radio access network (RAN), the second network node comprises a session management function, and the third network node comprises a user plane function (UPF).

3. The first network node of claim 1, wherein the one or more measurement or information is received from the WTRU, a location management function (LMF), or a network data analytics function (NWDAF).

4. The first network node of claim 1, wherein the plurality of QoS profiles comprise a plurality of respective packet delay budget values associated with the respective WTRU movement information.

5. The first network node of claim 1, wherein the processor configured to determine the change in the one or more of speed, location, or trajectory of the WTRU comprises the processor being configured to estimate the speed of the WTRU based on the one or more measurement or information.

6. The first network node of claim 1, wherein the processor is further configured to send, to the second network node, a fifth message indicating the selected QoS profile.

7. The first network node of claim 1, wherein the plurality of QoS profiles further comprise respective packet error rate (PER) values associated with the respective WTRU movement information.

8. A method for a first network node (RAN), the method comprising:
receiving, from a second network node (Session Management Function (SMF)), a first message comprising a plurality of Quality of Service (QoS) profiles, wherein the plurality of QoS profiles are associated with a plurality of respective WTRU movement information associated with a WTRU, and wherein the plurality of QoS profiles are associated with a plurality of respective indices;
determining, based on one or more of a measurement or information, a change in one or more of a speed, location, or trajectory of the WTRU;
selecting a QoS profile from the plurality of QoS profiles based on the determined change in the one or more of speed, location, or trajectory of the WTRU;
sending, to the WTRU, a third message comprising an index from the plurality of respective indices, to indicate the selected QoS profile, wherein the index is associated with the selected QoS profile; and
sending, to a third network node (UPF), a fourth message comprising the index, wherein the fourth message is associated with synchronizing QoS handling for the WTRU.

9. The method of claim 8, wherein the first network node comprises a radio access network (RAN), the second network node comprises a session management function, and the third network node comprises a user plane function (UPF).

10. The method of claim 8, wherein the one or more measurement or information is received from the WTRU, a location management function (LMF), or a network data analytics function (NWDAF).

11. The method of claim 8, wherein the plurality of QoS profiles comprise a plurality of respective packet delay budget values associated with the respective WTRU movement information.

12. The method of claim 8, wherein determining the change in the one or more of speed, location, or trajectory of the WTRU comprises estimating the speed of the WTRU based on the one or more measurement or information.

13. The method of claim 8, wherein the method further comprises sending, to the second network node, a fifth message indicating the selected QoS profile.

14. The method of claim 8, wherein the plurality of QoS profiles further comprise respective packet error rate (PER) values associated with the respective WTRU movement information.
